(19) United States
(12) Patent Application Publication
(10) Pub. No.: US 2025/0349197 A1
(43) Pub. Date: Nov. 13, 2025

(54) SYSTEMS AND METHODS FOR MULTI-LAYERED ACTIVITY MONITORING, FALL DETECTION AND PREDICTION USING WIRELESS SIGNALS

(71) Applicants: NEGAR GHOURCHIAN, MONTREAL (CA); HECTOR DOMINIGO OROZCO PEREZ, MONTREAL (CA); PEYMAN GHASEMI, CALGARY (CA); VAHID REZA ASGHARI, RICHMOND HILL (CA); QIANYU LIU, MONTREAL (CA); AZAR ZANDIFAR, VERDUN (CA); MICHEL ALLEGUE MARTINEZ, TERREBONNE (CA)

(72) Inventors: NEGAR GHOURCHIAN, MONTREAL (CA); HECTOR DOMINIGO OROZCO PEREZ, MONTREAL (CA); PEYMAN GHASEMI, CALGARY (CA); VAHID REZA ASGHARI, RICHMOND HILL (CA); QIANYU LIU, MONTREAL (CA); AZAR ZANDIFAR, VERDUN (CA); MICHEL ALLEGUE MARTINEZ, TERREBONNE (CA)

(21) Appl. No.: 19/201,421

(22) Filed: May 7, 2025

Related U.S. Application Data
(60) Provisional application No. 63/644,046, filed on May 8, 2024.

(51) Int. Cl. G08B 21/04

(52) U.S. Cl. CPC G08B 21/0423; G08B 21/043; G08B 21/0453

(57) ABSTRACT

Wireless communication systems continuously sense the state of the wireless channel in order to dynamically optimize the system but this fine-grained information can also be used for detecting motion within a sensing area covered by a wireless communication system as well as detecting and identifying human activities within the sensing area. Remote monitoring applications, particularly remote healthcare monitoring for elderly individuals and patients who require regular monitoring or have limited access to healthcare facilities or ability to exploit electronic devices, can exploit motion and activity detection/identification to provide monitoring and trigger alarms. It would be beneficial for such a monitoring system to not only incorporate wireless sensing capabilities for detecting motion or human activities but to support the integration of other external sensing modalities, such as those provided, for example, by an accelerometer, a microphone, vital signs monitoring, medication reminders, and nutritional tracking.

### FIELD OF THE INVENTION

This patent specification claims the benefit of priority from U.S. Provisional Patent Application 63/644,046 filed May 7, 2024; the entire contents of which are incorporated herein by reference.

### FIELD OF THE INVENTION

This invention relates to systems and methods of using wireless signals to create an active sensing area and characterizing the disturbance of the wireless signals to monitor and track activities and health status of human users in an indoor environment.

### BACKGROUND OF THE INVENTION

M any current wireless communication systems such as Long-Term Evolution (LTE), LTE-Advance, IEEE 802.11n, IEEE 802.11ac and IEEE 802.11ax continuously sense the state of the wireless channel through well-known signals, or pilot signals, in order to dynamically optimize the transmission rate or improve the robustness of the system. These channel sensing mechanisms are continuously improving and enable self-driven calibration systems and wireless signal pre-compensation and post-compensation techniques, significantly improving the quality of wireless communication.

M ore fine-grained information is available in modern communication systems and several approaches have been proposed in order to improve these systems. Accordingly these fine-grained measurements are not only valuable for controlling and optimizing communication networks and links but they can also be used for the purpose of detecting motion or human activities within a sensing area. Amongst these solutions are remote healthcare monitoring, particularly for elderly individuals and patients who require regular monitoring but may have limited mobility, limited access to healthcare facilities or ability to exploit electronic devices. Accordingly, it would be beneficial to provide remote communication between a user and a healthcare provider or caregiver, greatly enhancing quality of service provided to the user.

In particular it would be beneficial to provide the healthcare provider, the caregiver or even emergency services where the monitored motion or human activity is determined to be a fall of the user. In addition it would be beneficial for the monitoring system to not only incorporate wireless sensing capabilities for detecting motion or human activities but to allow integration of other external sensing modalities, such as those provided by an accelerometer, a microphone, vital signs monitoring, medication reminders, and nutritional tracking for example.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations within the prior art relating to systems and methods of using wireless signals to create an active sensing area and characterizing the disturbance of the wireless signals to monitor and track activities and health status of human users in an indoor environment.

In accordance with an embodiment of the invention there is provided a system comprising:
a plurality of wireless devices, each wireless device associated with a predetermined region of a sensing area and operating according to a common wireless standard; and
a device comprising at least a processor and a memory for storing computer executable instructions which when executed by the processor configure the device to:
   receive and store a plurality of metrics extracted from wireless signals transmitted and received by the plurality of wireless enabled devices;
   process the extracted plurality of metrics; and
   establish at least one of detection of a fall of a user within the predetermined region of the sensing area and a prediction of another fall by another user within the predetermined region of the sensing area.

In accordance with an embodiment of the invention there is provided a system comprising:
a device comprising at least a processor and a memory for storing computer executable instructions which when executed by the processor configure the device to:
   extract a plurality of metrics from a memory in communication with the device where the plurality of metrics were extracted from wireless signals transmitted and received by a plurality of wireless enabled devices associated with a predetermined region of a sensing area and operating according to a common wireless standard;
   process the extracted plurality of metrics; and
   establish at least one of detection of a fall of a user within the predetermined region of the sensing area and a prediction of another fall by another user within the predetermined region of the sensing area; wherein
the plurality of wireless devices are associated with a predetermined region of a sensing area and operate according to a common wireless standard.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 illustrates a system able to sense subject(s) within a sensing area via wireless signals by connecting at least two instances of the transceivers and/or plurality of devices;

FIG. 2 depicts an exemplary architecture of a system for remote healthcare monitoring system from the Wi-Fi measurements according to an embodiment of the invention;

FIG. 3 depicts an exemplary architecture of the proposed data preparation method; and

FIG. 4 depicts an exemplary architecture of the proposed fall detection, fall alert and calibration process.

### DETAILED DESCRIPTION

The ensuing description provides representative embodiment(s) only, and is not intended to limit the scope, applicability, or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may”, “might”, “can” or “could” be included, that particular component, feature, structure, or characteristic is not required to be included.

Reference to terms such as “left”, “right”, “top”, “bottom”, “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users.

Reference to terms “including”, “comprising”, “consisting” and grammatical variants thereof do not preclude the addition of one or more components, features, steps, integers, or groups thereof and that the terms are not to be construed as specifying components, features, steps or integers. Likewise, the phrase “consisting essentially of”, and grammatical variants thereof, when used herein is not to be construed as excluding additional components, steps, features integers or groups thereof but rather that the additional features, integers, steps, components, or groups thereof do not materially alter the basic and novel characteristics of the claimed composition, device, or method. If the specification or claims refer to “an additional” element, that does not preclude there being more than one of the additional element.

A “portable electronic device” (PED) as used herein and throughout this disclosure, refers to a wireless device used for communications and other applications that requires a battery or other independent form of energy for power. This includes devices, but is not limited to, such as a cellular telephone, smartphone, personal digital assistant (PDA), portable computer, pager, portable multimedia player, portable gaming console, laptop computer, tablet computer, a wearable device, and an electronic reader.

A “fixed electronic device” (FED) as used herein and throughout this disclosure, refers to a wireless and/or wired device used for communications and other applications that requires connection to a fixed interface to obtain power. This includes, but is not limited to, a laptop computer, a personal computer, a computer server, a kiosk, a gaming console, a digital set-top box, an analog set-top box, an Internet enabled appliance, an Internet enabled television, and a multimedia player.

A “subject” as used herein may refer to, but is not limited to, an individual or group of individuals. This includes, but is not limited to, private individuals, employees of organizations and/or enterprises, an unknown individual or an intruder, members of community organizations, members of charity organizations, men, women, and children. In its broadest sense the user may further include, but not be limited to, software systems, mechanical systems, robotic systems, android systems, etc. that may be characterized, i.e. identified, by one or more embodiments of the invention.

A “transmitter” (a common abbreviation for a radio transmitter or wireless transmitter) as used herein may refer to, but is not limited to, an electronic device which, with the aid of an antenna, produces radio waves. The transmitter itself generates a radio frequency alternating current containing the information to be transmitted which is applied to the antenna which radiates radio waves. A transmitter may be discrete, or it may form part of a transceiver in combination with a receiver. Transmitters may be employed within a variety of electronic devices that communicate by wireless signals including, but not limited to, PEDs, FEDs, two-way radios, and wireless beacons. A transmitter may operate according to one or more wireless protocols in dependence upon its design.

A “receiver” (a common abbreviation for a radio receiver or wireless receiver) as used herein may refer to, but is not limited to, an electronic device that receives radio waves via an antenna which converts them to a radio frequency alternating current wherein the receiver processes these signals to extract the transmitted information. Receivers may be employed within a variety of electronic devices that communicate by wireless signals including, but not limited to, PEDs, FEDs, two-way radios, and wireless beacons. A receiver may operate according to one or more wireless protocols in dependence upon its design.

A “wireless transceiver” as used herein may refer to, but is not limited to, a transmitter and a receiver comprising components needed for sending and receiving wireless signals, e.g. antenna, amplifiers, filters, mixers, local oscillators, ADC and DAC, and any other component required in the modulator and demodulator.

“Device-free technology” as used herein may refer to, but is not limited to, a system for detecting and/or identifying target user(s) or the subject(s) which does not require to wear any device with him/her/them in order for the system or the technology to know that there is human motion in the sensing area or to detect the type of activities or not that the subject(s) are performing.

“Device-oriented technology” as used herein may refer to, but is not limited to, a system for detecting and/or identifying target user(s) or the subject(s) which assumes, but not necessarily, that the subject(s) are wearing a device but irrespective of these assumptions tracks the device rather the individual.

A “wireless protocol” or “wireless standard” as used herein may refer to, but is not limited to, a specification defining the characteristics of a wireless network comprising transmitters and receivers such that the receivers can receive and convert the information transmitted by the transmitters. Such specifications may therefore define parameters relating to the wireless network, transmitters, and receivers including, but not limited to, frequency range, channel allocations, transmit power ranges, modulation format, error coding, etc. Such wireless protocols may include those agreed as national and/or international standards within those regions of the wireless spectrum that are licensed/regulated as well as those that are unlicensed such as the Industrial, Scientific, and Medical (ISM) radio bands and hence are met by equipment designed by a single original equipment manufacturer (OEM) or an OEM consortium. Such wireless protocols may include, but are not limited to, IEEE 802.11 Wireless LAN and any of their amendments, IEEE 802.16 WiMAX, GSM (Global System for Mobile Communications, IEEE 802.15 Wireless PAN, UMTS (Universal Mobile Telecommunication System), EV-DO (Evolution-Data Optimized), CDMA 2000, GPRS (General Packet Radio Service), EDGE (Enhanced Data Rates for GSM Evolution), Open Air, HomeRF, HiperLAN1/HiperLAN2, Bluetooth, ZigBee, Wireless USB, 6loWPAN, and UWB (ultra-wideband).

A “sensor” as used herein may refer to, but is not limited to, a transducer providing an electrical output generated in dependence upon a magnitude of a measure and selected from the group comprising, but is not limited to, environmental sensors, medical sensors, biological sensors, biometric sensors, chemical sensors, ambient environment sensors, position sensors, motion sensors, thermal sensors, infrared sensors, visible sensors, RFID sensors, and medical testing and diagnosis devices.

“Biometric” information as used herein may refer to, but is not limited to, data relating to a user characterised by data relating to a subset of conditions including, but not limited to, their environment, medical condition, biological condition, physiological condition, chemical condition, ambient environment condition, position condition, neurological condition, drug condition, and one or more specific aspects of one or more of these said conditions. Accordingly, such biometric information may include, but not be limited, blood oxygenation, blood pressure, blood flow rate, heart rate, temperate, fluidic pH, viscosity, particulate content, solids content, altitude, vibration, motion, perspiration, EEG, ECG, energy level, etc. In addition, biometric information may include data relating to physiological characteristics related to the shape and/or condition of the body wherein examples may include, but are not limited to, fingerprint, facial geometry, baldness, DNA, hand geometry, odour, and scent. Biometric information may also include data relating to behavioral characteristics, including but not limited to, typing rhythm, gait, and voice.

This invention relates to a system and methods of using wireless signals to create an active sensing area and characterizing the disturbance of the wireless signals to monitor and track activities and health status of human users in an indoor environment. A multifunctional system and methods are disclosed for monitoring user's activities, living condition and health status by tracking, and identifying their mobility and sleep patterns, location-based routines and abnormal events such as fall and pre-fall symptoms for users, especially elders or patients of indoor sensing areas such as senior residentials and rehabilitation centers. Within embodiments of the invention there is a motivation to utilize off-the-shelf devices such as access points (APs), laptops, or any devices equipped with a network interface card (NIC) that are ubiquitous in modern households and monitor the signal patterns between nodes of communication.

The present invention provides a system and methods for remote healthcare monitoring, which includes activity monitoring, fall detection, and fall prediction. The sensing infrastructure is comprised of existing wireless networks to cover an indoor area, and activity recognition and prediction models are designed based on monitoring and quantifying changes in surrounding wireless signals caused by human physical movements and activities within the sensing area. Intelligent algorithms are utilized to construct an activity recognition model that monitors the daily activities of a human user within the sensing area and identifies if significant physical movement activity has occurred. Additionally, a fall model is proposed to distinguish different types of daily activities, including intentional events such as walking and sitting, from unintentional motion events such as falling. The system also includes a predictive model that uses movement and behavioral patterns of the user to predict whether a fall event is likely to occur in the future. By leveraging wireless signals from existing infrastructure, the system provides a non-intrusive and cost-effective solution for remote healthcare monitoring, particularly for elderly individuals and patients who require regular monitoring but may have limited mobility or access to healthcare facilities. The system also incorporates features for remote communication between the user and healthcare providers or caregivers, greatly enhancing its overall functionality and usefulness. An alert system is included to notify caregivers or emergency services in the event of a fall.

In addition, the system is designed with the flexibility to integrate external sensing modalities, such as accelerometer, microphone, vital signs monitoring, medication reminders, and nutritional tracking. Medication reminders may be integrated by an application programming interface (API) of the system accessing a medication reminder software application associated with a user, a pharmacy, a clinician or caregiver for example, or a medication reminder. Similarly nutritional tracking may be integrated by another application programming interface (API) of the system accessing a nutritional tracking software application associated with the user, a facility within which the user is resident permanently or temporarily, another user associated with the user and a caregiver for example.

By incorporating these features, the system can offer a more comprehensive and personalized approach to remote healthcare monitoring and support for elderly and vulnerable populations. These additional modalities can be seamlessly integrated with the existing infrastructure, providing a unified platform for efficient and effective monitoring of various aspects of an individual's health status.

The global population is getting older, and this trend is being experienced by all countries. There is a rapid increase in the number and percentage of individuals classified as elderly, which is defined as those aged 65 years or older. By 2050, it is projected that the elderly population will constitute 17% of the world's total population, with those aged over 60 making up 22% of the population. Around one-third of older adults aged 65 or older who live in the community experience at least one fall per year, and a significant number of them suffer from multiple falls. Additionally, falling rates increase exponentially with age, particularly for those above the age of 65. The severity of a fall for an elderly person is closely linked to the amount of time they take to get up or receive assistance. According to research, even in cases where there is no direct injury, half of the elderly individuals who fell and remained unable to get up for an hour experienced a fatal fall. Therefore, it is extremely critical that the fall accident is detected in a timely manner and is reported to family members or healthcare providers.

Sensing technologies currently used for human activity recognition and fall detection can be broadly classified into two categories: device-oriented and device-free approaches. Device-oriented systems rely on wearable or portable sensors such as accelerometers, radio frequency identification (RFID), gyroscopes, pressure sensors, and smartphones. These sensors are effective for tracking human movements but require users to wear or attach the sensors to their body, which may not always be feasible, especially for elderly individuals. On the other hand, there is an increasing interest in device-free passive (DFP) sensing, as it does not require human subjects to carry or wear any mobile devices. Computer vision-based systems are highly accurate but require a line-of-sight (LoS) setting with good lighting conditions, and users may have privacy concerns with in-home cameras. To track human motion in a more privacy-preserving way, many non-intrusive techniques have been proposed, such as ambient sensing, Radio-Frequency Tomography (RFT), radar systems, ultra-wideband technology, and wireless communication using WiFi signals.

Among these techniques, WiFi Received Signal Strength Indicator (RSSI) and WiFi Channel State Information (CSI) have become widely adopted due to their ubiquity and low overhead, using already deployed WiFi infrastructures. Furthermore, WiFi CSI-based approaches generally achieve better performance compared to RSSI-based measurements, as they take advantage of system robustness. As a result, with the development of communication technologies and the rapid growth of the Internet of Things (IoT), understanding elderly people's behavior using Wi-Fi CSI-based solutions has become an important and emerging topic in both research and industry communities.

Many currently used wireless communication systems such as Long-Term Evolution (LTE), LTE-Advance, IEEE 802.11n, IEEE 802.11ac (WiFi 5), and IEEE 802.11ax (WiFi 6) continuously sense the state of the wireless channel through well-known signals, or pilot signals, in order to dynamically optimize the transmission rate or improve the robustness of the system. These channel sensing mechanisms are continuously improving and enable self-driven calibration systems and wireless signal pre-compensation and post-compensation techniques, significantly improving the quality of wireless communication.

More fine-grained information is available in modern communication systems and several approaches have been proposed in order to improve these systems. For example, a method that provides periodic channel state information (CSI) data has been developed. However, these fine-grained measurements are not only valuable for controlling and optimizing communication networks and links as they can also be used for the purpose of detecting motion or human activities within a sensing area.

Several signals are broadcasted or emitted in type of frames by the stations (STA) and Access Points (APs) in WiFi networks even without requiring association between them. For example, before two devices can associate to each other, each of them can read frames from the environment and each of them can decide to broadcast or send one or multiple frames or wireless signals in general.

The present invention pertains to non-intrusive, passive WiFi-based systems and methods for monitoring the health status of elderly individuals and/or patients, with the aim of promoting their mental and physical well-being when living independently. Specifically, the methods aim to monitor and address concerns such as whether a senior living alone engages in sufficient physical activity, whether they have experienced a fall, and whether a fall is likely to occur based on patterns observed in their daily activities, such as their walking gait pattern.

Tracking activity events in a living area for example provides tools to assess a subject's behavioural analysis such as the pattern of normal daily activities and identify if a user is experiencing an unexpected activity such as fall. Recent studies suggest that many behavioral patterns and environmental attributes are associated with increased risk of fall. Moreover, falls with a “long lie” (a long waiting time on the ground after a fall before help arrives), are associated with increased mortality independent of injury severity. Therefore, activity monitoring when at home is crucial in elder care to predict and prevent anomalies and reduce the respond time in case of a fall accident.

The changes and disruption of wireless signals transmitted and received by the plurality of wireless devices are collected and analyzed to infer normal activity and fall events within the sensing area. M ore particularly, using CSI information through time a method is proposed that models and estimates the activities of a subject within the sensing area whether the subject moves in the expected way or is experiencing unexpected accidents such as fall.

This invention relates to system and methods of using wireless signals to create an active sensing area and characterizing the disturbance of wireless signals to monitor the activities of a moving subject, recognize incidents such as falling, predict the probability of fall incident for a user based on their patterns of daily behaviour such as walking gait and log all activities of people within indoor environments.

A method for building an initial event detection model that includes receiving and analysing wireless signals, while a user is present in within sensing environment and determine if a significant “activity event” such as walking, sitting, standing, exercising or falling has occurred. The method includes various signal processing, data mining, machine learning and feature extraction techniques to statistically formulate the correlation between wireless signal readings and the identifying a significant activity event inside the sensing area.

A method for building a fall detection model to classify an “activity event” into a normal daily event or abnormal incident event. The method includes Artificial intelligence (AI)-based fall detection method, which exploits sequential information from a device-free activity detection module followed by various signal processing, data mining, machine learning (including but not limited to deep learning, transfer learning, supervised and unsupervised learning) and feature extraction techniques to statistically formulate the correlation between wireless signal readings and the type of activity (normal or fall-like) sensed within the sensing environment. This correlation can be directly learned from wireless readings or indirectly from a model mapped between wireless signals and other sensory information such as accelerometer, sounds from microphones, and images from videos.

A model for real-time evaluation of fall detection status which receives a live stream of wireless signal and their activity type predictions from past and present and apply a postprocessing method of the sequential output of “activity event” and “fall detection” to make a final decision if a fall accident has occurred within the sensing area.

The method can also make use of other auxiliary information such as, but not limited to, environmental attributes (e.g., time of the day, location of the activities, time of the last activity), behavioral patterns (e.g., lack of activity, medication usage, sleep hygiene) and biological and demographic attributes to enhance the final decision.

A method for building a fall prediction model, which utilizes computed statistics from wireless signals to identify and qualify behavioural risk attributes such as walking pattern (gait) disturbances, lack of exercise, or lack of sleep, and calculate a probabilistic score to predict if a user within the sensing area is likely to fall or not. This training phase may, but not need to, be conducted in the user's environment. Pre-recorded data from test environments might be used to train the predictor model.

A provisional method to re-calibrate the activity even and fall detection system in case of performance deterioration due to specific environment characterization. The data collected while calibration can be used to augment the pre-recorded data, and then to improve the pre-trained probabilistic model.

In modern wireless communication systems, a wireless signal, such as channel state information (CSI), travels between a transmitter and receiver through multiple transmission channels using a method called Orthogonal Frequency Division Multiplexing (OFDM). This involves broadcasting the signal simultaneously on several narrowly separated sub-carriers at different frequencies within each channel, which increases the data rate. An example of a wireless measurement that relates to the channel properties is the Channel State Information values, which describe how the signal is transmitted through the channel and reveal variations and distortions caused by scattering, fading, and power decay with distance. The CSI values can be obtained at the receiver and used to quantitatively analyse the behaviour of signal propagation within a wireless-covered area, which can identify and measure different types of disturbances, including human activities and the location and characteristics of movement. These measurements form the basis of some embodiments of the invention.

This invention presents a passive healthcare and elderly care monitoring system that uses wireless technology to sense and monitor human movements within an indoor environment and detect and predict accidents, such as falls, that may occur to a user. The system analyzes changes in wireless signals such as WiFi signals, as represented by channel state information (CSI) over time, due to human body presence and motion in the observed environment. Advanced artificial intelligence and machine learning techniques are then applied to differentiate between normal daily activities, such as walking and running, and abnormal events, such as a fall. Additionally, the system estimates the risk of such incidents per user based on their individual behavioral patterns such as walking gait and mobility patterns.

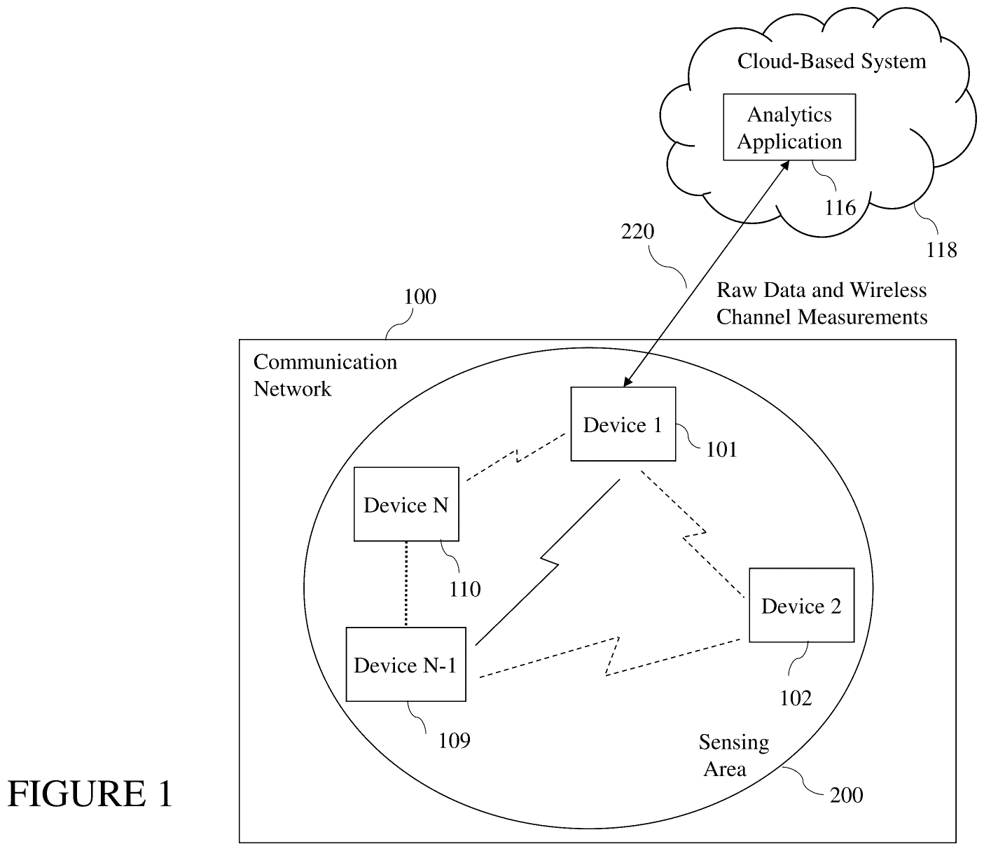

A wireless device-free motion detection system is illustrated in FIG. 1. This system consists of a minimum of two transceivers, namely two of Device 1 101, Device 2 102, Device N−1 109 and Device N 110 as depicted in FIG. 1, which are connected through one or more standards such as WiFi. Feasible device-free motion detection can be achieved by analyzing certain metrics or measurements, as the system takes advantage of the fact that wireless signals exchanged between transceivers can be distorted by moving objects in the covered area.

In one of the embodiments described herein, a Communication Network 100 comprises at least two devices, namely two of Device 1 101, Device 2 102, Device N−1 109 and Device N 110 as depicted in FIG. 1 as shown in FIG. 1. By employing any two instances of devices, namely two of Device 1 101, Device 2 102, Device N−1 109 and Device N 110 as depicted in FIG. 1, a Sensing Area 200 is created as illustrated in FIG. 1. In this Communication Network 100 any device within the Sensing Area 200 can act as a transceiver. The transceivers creating an active Sensing A rea 200 can detect movements of humans, pets, or any other moving objects based upon processing the wireless signals communicated between the two transceivers. This Sensing Area 200 may be situated within a larger area that could be any residential or commercial space, either indoor or outdoor. The proposed system comprises at least one active Sensing A rea 200, but it may also comprise multiple sensing areas or a single active sensing area. The system can perform motion detection computation either on-premise or on the local area network (LAN) devices, or on cloud-based computing resource(s), such as Cloud-based System 118, as shown in FIG. 1 which includes an Analytics Application 116 for example. The Cloud-based System 118 may be linked to the Communication Network 100 directly or via one or more other networks.

If part or all of the Analytics Application 116 is hosted in a remote facility, at least one of Device 1 101 through to Device N 110 should be capable of connecting to the remote network where the Analytics Application 116 is hosted. If additional devices, such as Device 1 101, Device 2 102, Device N−1 109 and Device N 110, for example, are incorporated into the Sensing A rea 200 then the Sensing Area 200 is enhanced and/or extended according to the number and location of new devices available within the Communication Network 100 and their wireless communication range. Enhancement of the sensing area occurs as a result of the increase in the number of data sources available. Extension of the Sensing A rea 200 therefore occurs as a result of the increase in overall reach of the Communication Network 100 from the devices. The scope of the systems and methods proposed herein are not limited by any network topology. The Communication Network 100 may be created by following any of the regulated communication standards, e.g. an IEEE 802.11 standard family, an existing wireless standard or a new wireless standard.

The system according to an embodiment of the invention can collect, through at least one of the devices in the Communications Network 100 where the transceivers of any two or more of Device 1 101, Device 2 102, Device N−1 109 and Device N 110 are connected, a wide range of information from all or any of the devices (e.g. transceivers of two or more of Device 1 101, Device 2 102, Device N−1 109 and Device N 110) within the active Sensing Area 200. For example, this information includes but is not limited to, Physical Layer (PHY layer) data, Media Access Control (MAC) sublayer data and Logical Link Control (LLC) sublayer data where the MAC and LLC layers are two sublayers of the Data Link (DL) layer of the OSI model. The PHY layer and the DL layer contain information including, for example, the frequency response of the channel, the phase response of the channel, the impulse response of the channel, received signal strength indicators (RSSI), media access control addresses (MAC addresses), capture of probe requests, capture of any broadcasting frame before the association between devices, control frames after or before association between devices, any frame related to the association process, and any other statistic that describes the wireless communication link between paired devices.

The method proposed herein analyses flow of wireless channel responses between connected devices, such as Device 1 101, Device 2 102, Device N−1 109 and Device N 110 in multiple frequencies and spatial streams in the communication channel. This is referred to as Raw Data or Wireless Channel Measurements (hereinafter Wireless Data) 220 in FIG. 1, which is the input or part of input to the methods proposed herein.

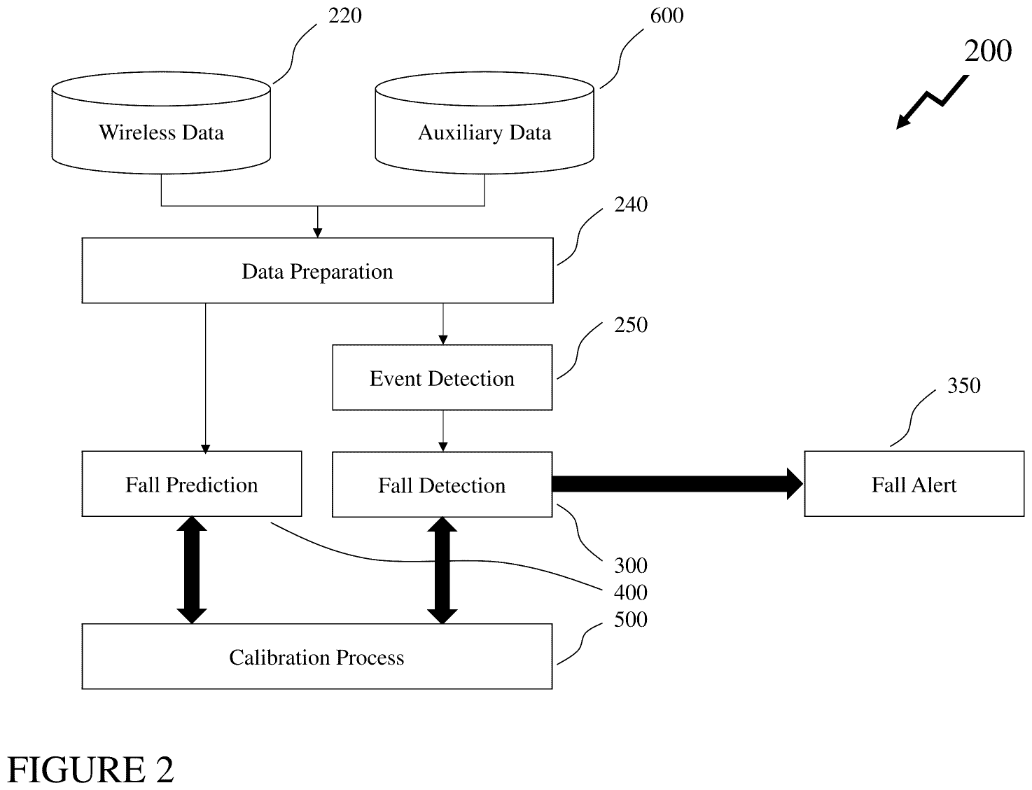

FIG. 2 illustrates a general exemplary system overview of a wireless device-free healthcare monitoring and fall detection system, Fall Monitoring System 200, according to an embodiment of the invention. The system uses Wireless Data 220 to monitor the influence of human body movements and activities on the changes in strength and pattern of wireless communications in order to capture and predict undesired events such as falling within the active sensing area 200. According to FIG. 2, other key components of the fall monitoring system include a Data Preparation module 240, an Event Detection module 250, a Fall Detection module 300, a Fall Alert module 350, a Fall Prediction module 400 and a Calibration Process module 500. The Fall Monitoring System 200 may also employ other data such as Auxiliary Data 600 depicted in FIG. 2.

Within the following description with respect to an exemplary embodiment of the invention the inventors present description of these different modules and units, as well as the way which they function and interact with each other. However, it would be evident that within other embodiments of the invention data may flow between modules in different sequences or to-from other modules forming part of the modules identified or others not explicitly depicted.

The Wireless Data 220 may include, but is not limited to, information such as channel state information (CSI) and RSSI measurements, data link layer information such as MAC addresses for example, user interface application layer channel state information. All analytic modules within the Fall Monitoring System 200 rely primarily on this information as their main source discretely or in conjunction with other data such as that provided by Auxiliary Data 600 which may include data extracted from other sources such as accelerometer, a microphone, vital signs monitor, a sensor, a medication reminder, and a nutritional tracking application.

The Fall Monitoring System 200 and all analytics modules within also consume another source of information, which is referred to as auxiliary data 600. Auxiliary data 600 refers to pieces of information that are extracted from sources other than quantified Wi-Fi-based measurements. This information may include, but is not limited to, time-based information (such as hour, day, week and month), visual information captured by cameras, such as images and videos, and/or auditory information captured by microphones such as speech or ambient noise, and/or non-Wi-Fi-based environmental information (such as temperature, humidity, pressure and ambient light, occupancy), and/or geospatial information captured by GPS or other location-based sensors, such as accelerometers, gyroscopes, or magnetometers, and/or biometric information captured by sensors such as electrocardiogram (ECG) sensors, photoplethysmogram (PPG) sensors, electroencephalogram (EEG) sensors and eye-tracking sensors, for example, as well as sensors that can measure physiological or behavioral characteristics of individuals, such as heart rate, blood pressure, or gait, collected from the Sensing Area 200 and/or from devices owned by the residents, users, human subjects etc. present within the sensing area 200. Additionally, other sensors or devices which may provide data may include robotic systems, android systems, security systems etc.

Referring to FIG. 2, the Wireless Data 220 and Auxiliary Data 600 are transferred to a Data Preparation module 240, where the raw data from all sources is cleaned, processed, and prepared for further analysis using variety of signal processing, statistical analysis, data mining and machine learning methods in order to characterize events provoked by static or moving objects by creating representative models.

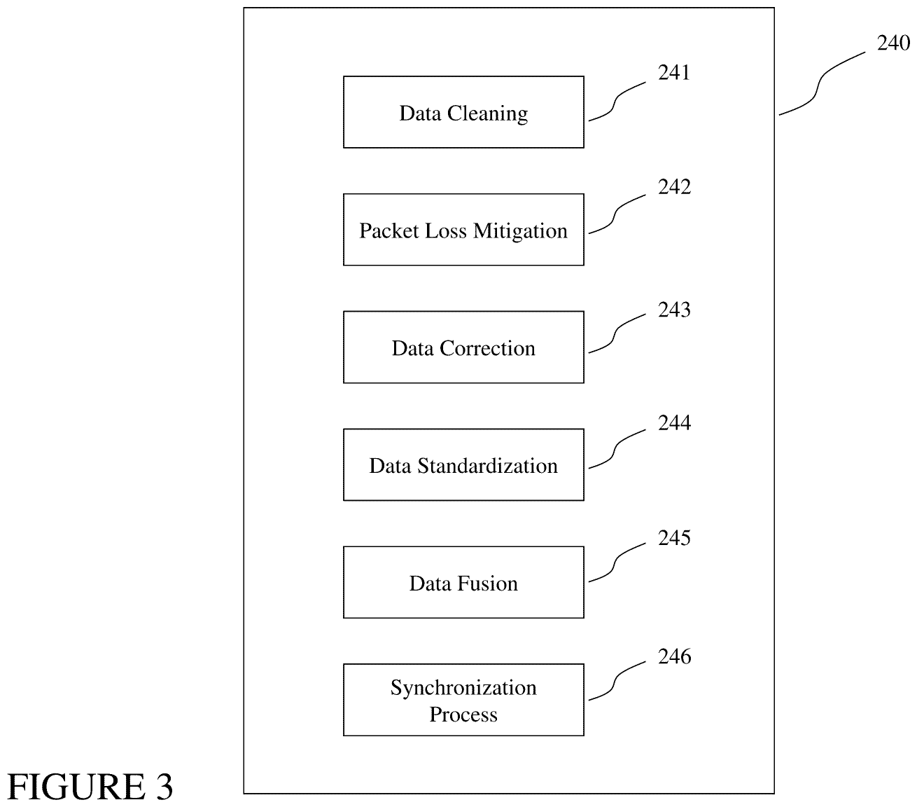

The Data Preparation module 240 is a component of the system that is designed to clean, transform, and prepare raw data, including but not limited to CSI signals and other auxiliary information for analysis. The quality and structure of the CSI measurements can significantly impact the accuracy and effectiveness of the analysis, therefore several stages of data transformation and cleaning, data summarization and data standardization are applied. An exemplary architecture of such a Data Preparation module 240 is shown in FIG. 3.

Referring to FIG. 3, some common stages in Data Preparation module 240 include but are not limited to Data Cleaning module 241 of the CSI data extracted from the physical layer of Wi-Fi devices, which leverages high-resolution information regarding the communication channel. Wireless signals, including CSI values, are affected by the motion of human body parts resulting in different patterns, which can be used to identify different human activities such as normal daily actions such as walking, standing, and sitting, or unexpected actions such as falling. However, the CSI measurements can be affected by various unwanted intrinsic or environmental factors, and the raw values are too noisy to be used directly for human activity analysis. Thus, the initial step is to use noise removal and anomaly removal algorithms to eliminate unwanted high-frequency components. The primary goal of the data cleaning module is to remove noise in the subcarrier dimension without compromising high-frequency components, especially when the signal density is low. There are several filter implementations that could be considered for the noise removal step in the preprocessing module. Some examples include median filter, moving average filter, K alman filter, wavelet transform filter and Butterworth filter.

Referring to FIG. 3, Packet Loss Mitigation module 242 deals with occurrence of packet loss and latency in wireless communication connections. To mitigate these issues, various recovery techniques, such as interpolation, are implemented on each stream to maintain a constant sampling rate. Data Correction module 243 is responsible for identifying and removing or correcting any errors, inconsistencies, or missing values in the raw data. This is important because errors in the data can skew the results of subsequent analysis and lead to incorrect conclusions.

Also depicted in FIG. 3 is Data Standardization module 244 which involves converting the raw data into a format that is more suitable for analysis. For example, this might involve converting categorical data into numerical data, normalizing the CSI measurements to a fix-power scale, or reducing the dimensionality of the CSI measures. Further, Data Fusion module 245 is a crucial component that integrates and combines data from multiple sources, including wireless signals such as channel state information (CSI) and other sensors like accelerometers. Its primary objective is to address any inconsistencies or conflicts that may arise when working with data from diverse sources. One significant challenge in this process is dealing with data sources that have different time resolutions, structures, or formats. Consequently, the main purpose of this module is to synchronize the different sources, especially in real-time analytics, to ensure that the data captured by various sensors corresponds to the same moment in time. This synchronization is vital for accurately analyzing and interpreting fall and non-fall events in the monitoring environment, as well as for effectively utilizing the combined data.

Synchronization Process 246 includes several steps, including timestamp alignment, time delay compensation, data alignment and validation and annotation. Timestamp alignment can be done based on internal clock or other timing mechanisms. The first step is to align the timestamps of all sensors to a common reference time scale. This can be achieved by using time synchronization protocols or by calibrating the sensors to a central time source. Also, sensors may introduce different time delays in capturing and transmitting data due to factors such as processing time, communication latency, or sensor placements. To synchronize the data, these time delays need to be compensated for. This can be done by measuring the time delay for each sensor and applying appropriate adjustments to align the data streams.

Once the timestamps and time delays are adjusted, the data streams from different sensors can be aligned. This involves matching the corresponding data points from each sensor based on their synchronized timestamps. Data alignment can be achieved by interpolation, resampling, or other techniques depending on the specific requirements of the consuming module.

The final stage of Synchronization Process 246 involves validating the initial alignment by comparing the captured data and identifying any discrepancies or inconsistencies. For instance, if one sensor detects movements or activities that are not detected by other sensors, it is necessary to resolve the conflict before proceeding with further analytics and decision-making. Another aspect of validation is annotating the fused data sources whenever applicable and feasible. This annotation is particularly important to prepare the data for subsequent analysis using artificial intelligence and machine learning techniques in modules such as Event Detection module 250, fall detection 300, and fall prediction 400. To achieve this, ground truth information of events within the sensing area 200 is extracted from various data sources and aggregated with CSI measurements. Multiple fusion techniques, including rule-based approaches, statistical models, machine learning methods, and probabilistic frameworks, are employed to address inconsistencies and generate meaningful annotations that can be used for actionable insights.

Referring to FIG. 2, after Data Preparation module 240, the enhanced and synchronized data is transferred to the Event Detection module 250 where the fused data, which has been synchronized and validated from various sensors, is used to identify, and detect significant activities or events within the Sensing Area 200. The event detection mechanism acts as an activation system for the Fall Detection process 300, triggering it only when significant activity events are detected. This ensures that the fall detection algorithms are invoked selectively, focusing computational resources on detecting critical events such as falls, while minimizing unnecessary processing during periods of routine activity. This is achieved by analyzing the combined information and identifying patterns, anomalies, or noteworthy occurrences that indicate the presence of events of interest. The main goal is to discern if a noteworthy “activity event,” encompassing routine daily actions like walking, sitting, standing, exercising, as well as abnormal occurrences like falling and tripping, has taken place. Concurrently, the aim is to filter out anomalies and inconsequential events, such as non-human mechanical motions, that could induce fluctuations in sensory data. To achieve this, the system incorporates a range of signal processing, data mining, feature extraction, machine learning, and artificial intelligence techniques.

Referring to FIG. 2, Event Detection module 250 starts by employing techniques to extract essential features or parameters from the signal data. These features encompass signal strength, frequency content, temporal variations, and other relevant attributes. Subsequently, after the event detection mechanism processes this information, more sophisticated analysis is conducted to precisely identify and characterize activity events within the sensing environment.

Once the feature space is prepared, the event detection module proceeds to make a series of decisions to identify the time frames where events are qualified. These decisions encompass various techniques such as thresholding, clustering, and anomaly detection techniques (for example, Isolation Forests, One-Class SVM, or Autoencoders). Through these methods, the module effectively determines which time frames contain significant activity events, thereby facilitating the accurate detection of meaningful occurrences within the sensing area. These decision-making processes are crucial for ensuring that the event detection system operates efficiently and reliably, enabling it to discern and respond to relevant events while filtering out irrelevant noise and background activity, improving its robustness and adaptability.

After detecting significant events by Event Detection module 250, the Fall Detection module 300 is employed to identify and classify instances of falls within the monitored environment. Leveraging the selected events from the Event Detection module 250, this module employs advanced algorithms and machine learning techniques to differentiate between normal activities and fall events. Its primary objective is to accurately detect falls while minimizing false positives.

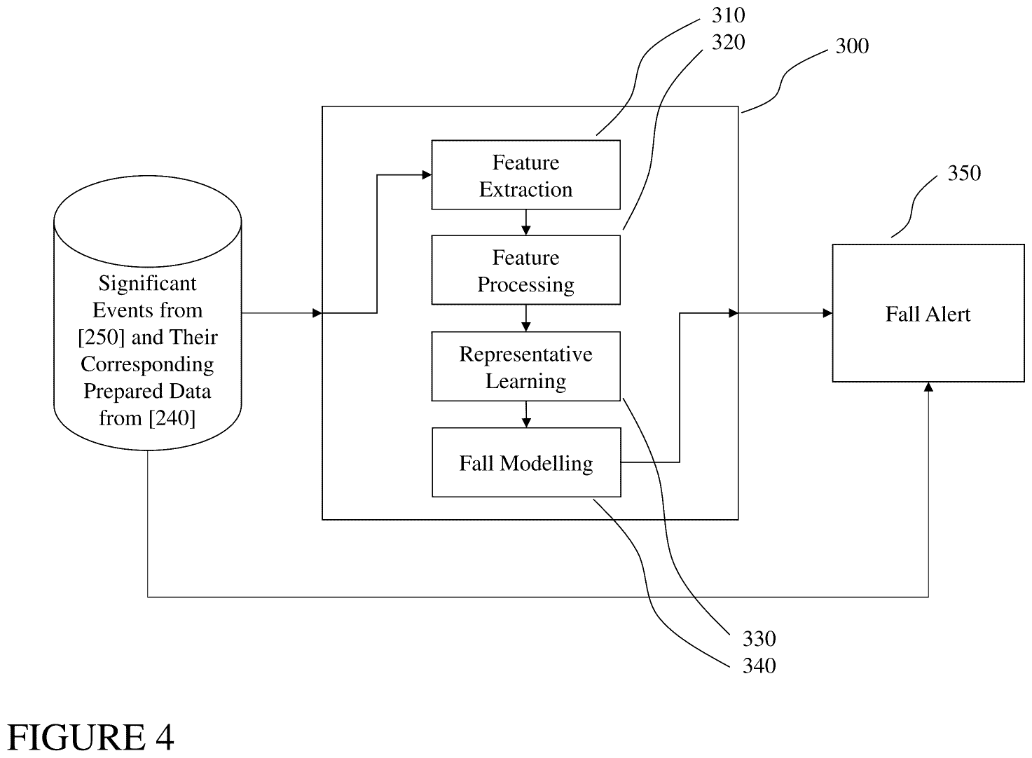

Now referring to FIG. 4 there is depicted an exemplary implementation of the proposed Fall Detection module 300 and its interactions with Fall Alert module 350. As depicted the Fall Detection module 300 consists of a few processes and receives data such as significant events from Event Detection module 250 and the corresponding prepared data from Data Preparation module 240. In Feature Extraction 310, a significant role is played by capturing relevant information from wireless signals and other auxiliary data streams. Various techniques are utilized by the system to extract essential features or parameters from the CSI measurements and other synchronized data sources. These extracted features encompass a diverse range, including but not limited to, statistical time domain features such as mean, standard deviation, median absolute deviation (MAD), coefficient of variation, entropy, and autocorrelation, computed over specific time intervals across activity levels. Additionally, frequency domain features, such as Hilbert Huang Transform (HHT), Mel-Frequency Cepstrum coefficients (MFCC), Fast Fourier Transform (FFT), and Short-Time Fourier Transform (STFT), are utilized. Moreover, highly comparative time-series analysis techniques (HCTSA) are employed to further enhance the characterization of the data and extract relevant insights. These multifaceted feature extraction methods enable comprehensive analysis and interpretation of the data, facilitating accurate identification and classification of activity events within the sensing environment.

Following Feature Extraction 310, as depicted in FIG. 4, the subsequent step in the pipeline is Features Processing 320. In this module, the extracted features undergo normalization and scaling to ensure that they are on a similar scale and have a comparable impact on the model training process. This step prevents features with larger scales from dominating the learning process. Techniques such as Min-Max Scaling or Z-score Standardization are applied to achieve this. Following normalization, a feature selection process is performed to choose the most relevant features for the model. This step helps reduce dimensionality and computational complexity while improving the model's generalization and interpretability. Techniques such as Recursive Feature Elimination (RFE) or L1 regularization are used for feature selection.

Referring for FIG. 4, module Representative Learning 330 focuses on learning a compact and informative representation of the data by identifying prototypes or representatives that capture the essential characteristics of the dataset. These representatives serve as condensed versions of the original data and/or extracted features, facilitating efficient processing and analysis. Various techniques are usually used to infer meaningful representatives of wireless signals that can assist classification of Fall events.

In an exemplary implementation, techniques such as autoencoders, Principal Component Analysis (PCA), and k-means clustering were employed to serve as representative spaces for capturing changes in wireless signals. Autoencoders are neural network architectures used for unsupervised learning, comprising an encoder network that compresses input data into a latent space representation and a decoder network that reconstructs the original data from the compressed representation. The compressed latent space serves as a representative encoding of the input data. In another example, PCA, a dimensionality reduction technique, was utilized to project the data onto a lower-dimensional subspace while retaining the maximum variance. The principal components obtained through PCA serve as representative axes along which the data is most spread out.

The final step in the Fall Detection process 300 is Fall Modelling 340, which incorporates data mining and machine learning algorithms to analyze the preprocessed data. These techniques aim to identify patterns, correlations, and statistical relationships between the wireless signal readings and the occurrence of significant activity events. Through training the model on a labeled dataset, the system learns to recognize the specific characteristics and signatures associated with different activity events.

Examples of such supervised learning models include conventional methods such as Support Vector Machines (SVM), Random Forests, and Gradient Boosting Machines (GBM) and deep learning models like Convolutional Neural Networks (CNNs), Recurrent Neural Networks (RNNs), and U-Nets, which are especially useful for semantic segmentation tasks, such as identifying relevant regions in wireless signal data.

Through the integration of signal processing, data mining, machine learning, and feature extraction techniques, the system creates a statistical model that correlates the wireless signal readings with the occurrence of significant activity events within the sensing area.

Referring to FIG. 4, the Fall Modelling 340 incorporates machine learning techniques to differentiate between normal activities and incidents such as fall events. These techniques leverage either direct learning from wireless signals or indirect learning from synchronized sensory information, such as accelerometers, sounds from microphones, and images from videos. Transfer learning methods are applied to facilitate learning from a different source domain to improve the model's ability to discern the target events accurately.

In an exemplary implementation, a model trained on accelerometer data may have learned features indicative of specific movement patterns associated with falls, such as rapid changes in acceleration, sudden drops, or unusual orientations of the device. By fine-tuning the parameters of this pre-trained model or using it as a feature extractor, the knowledge acquired from the accelerometer data can be transferred to enhance the performance of a fall detection model trained on wireless signals. This enables the fall detection model to capitalize on the insights gained from the accelerometer data, despite differences between the two sensor modalities. This approach proves particularly valuable in scenarios, where obtaining labeled data for training fall detection models using wireless signals is limited or costly. Leveraging knowledge from the accelerometer data allows the fall detection model to achieve improved efficiency and effectiveness in identifying fall events based on wireless signal data.

Referring to FIG. 4, upon receiving the raw outputs from the Fall Detection module 300, the Fall Alert module 350 processes this information in conjunction with various auxiliary data sources to enhance the accuracy and reliability of fall alerts. In particular, the module leverages additional environmental attributes such as the time of day, location of activities, and time since the last activity. By considering contextual factors, the system can better assess the likelihood and severity of a fall event.

The Fall Alert module 350 functions as a critical component within the comprehensive system for activity monitoring, fall detection, and prediction in indoor environments. This module is responsible for receiving the raw outputs generated by the Fall Detection 300 models for each period of time, thereby providing real-time notifications and alerts in the event of a detected fall or potential fall risk.

Furthermore, Fall Alert module 350 integrates behavioral patterns, including indicators of activity levels, medication usage, and sleep hygiene, into its decision-making process. These behavioral insights offer valuable context for interpreting fall detection outputs and determining appropriate response actions.

Additionally, the module incorporates biological and demographic attributes to further refine its fall alert notifications. By considering factors such as age, gender, medical history, and physical condition, the system can tailor its response strategies to meet the specific needs of individual users.

To integrate the Fall Alert module 350, a range of post-processing methods are deployed, encompassing techniques including but not limited to filtering, thresholding, ensemble methods, decision trees, and Gaussian processes. These methods are instrumental in augmenting the system's efficacy by swiftly recognizing and responding to fall-related incidents. By delivering timely notifications and alerts, the module significantly enhances safety, well-being, and reassurance for users within indoor environments.

Referring to FIG. 2, Fall Prediction module 400 serves as a proactive tool for identifying and mitigating fall risk. The primary goal of the Fall Prediction module 400 is to anticipate the likelihood of a fall occurring based on a user's behavioral patterns and environmental factors. By analyzing various data sources and employing predictive modeling techniques, this module aims to provide proactive insights to mitigate fall risks and enhance user safety.

In the Fall Prediction module 400, wireless signals and/or a fusion of other sensory information are leveraged to model characteristics associated with fall risk factors identified in relevant studies. These factors include gait, balance, step count, and other mobility-related metrics, which have been correlated with an increased risk of falls in both healthy seniors and individuals with mobility or cognitive impairments. By analyzing the combined data from diverse sensors, the system extracts features indicative of these risk factors and incorporates them into predictive models. This holistic approach enables the system to capture a comprehensive picture of an individual's movement patterns and behavior, allowing for more accurate assessments of fall risk and proactive prediction of potential fall events.

The Fall Prediction module 400 comprises feature extraction, predictive modeling, risk assessment, and model refinement. Similar to fall detection, various techniques are employed by the system for feature extraction to extract essential parameters from the CSI measurements and other synchronized data sources. These extracted features encompass a diverse range, including but not limited to time domain metrics such as mean, standard deviation, and entropy over specific time intervals to capture temporal variations, frequency domain analysis such as FFT, STFT, and wavelet transform, as well as pattern recognition methods such as principal component analysis and autoencoders

After feature extraction, various machine learning algorithms are employed to develop predictive models based on the extracted features. Examples of such methods include Support Vector Machines (SVM), Gradient Boosting Machines (GBM), and Long Short-Term Memory (LSTM) Networks, which are particularly suited for sequential data analysis and modeling temporal dependencies.

Predictive models assess the user's fall risk by analyzing the extracted features and environmental factors. Examples of risk assessment methods include Probabilistic Models, where Bayesian Networks or Gaussian Processes provide probabilistic outputs indicating the likelihood of a fall event. Decision Trees can derive simple decision rules to classify users into different risk categories based on feature thresholds. Additionally, Regression Analysis, whether linear or logistic regression models, quantifies the relationship between predictor variables and fall occurrence probabilities.

Finally, in model refinement stage, continuous improvement and refinement of predictive models ensure their accuracy and adaptability. Example implementation of such methods for model refinement includes but not limited to, Cross-Validation; techniques like k-fold cross-validation are used to assess model performance and prevent overfitting, Hyperparameter Tuning; Grid search or random search algorithms optimize model hyperparameters to improve predictive accuracy, and Ensemble Methods; combining predictions from multiple models, such as bagging or boosting, enhances overall model robustness and generalization.

Referring to FIG. 2, in addition to the Fall Detection 300, Fall Alert 350 and Fall Prediction 400 modules, the system includes a Calibration Module 500 which is responsible for monitoring and maintaining the accuracy and performance of the deployed Fall Detection 300 and Fall Prediction 400 module models over time. The Calibration Module 500 employs various techniques to detect any degradation in accuracy or performance, such as monitoring changes in environmental conditions, analyzing feedback from users or caregivers, and evaluating the system's performance metrics.

Upon detecting degradation, the calibration module automatically applies corrective measures to improve the quality of the models. These measures may include retraining the machine learning algorithms with updated data, adjusting the filtering methods to enhance noise reduction, or fine-tuning the model parameters to adapt to changing conditions.

By continuously monitoring and calibrating the system, the Calibration Module 500 ensures that the fall detection and fall prediction capabilities remain reliable and effective, even in dynamic and evolving environments.

In an exemplary implementation, the following methodologies are employed to guarantee robustness in the Fall detection and Fall prediction system, these being Periodic Retraining, Incremental Learning, Online Learning, Parameter Tuning, Anomaly Detection, User Feedback and Dynamic Threshold Adjustment.

Periodic Retraining, where the system periodically retrains the machine learning models using new labeled data collected over time from real-world feedback provided by user of the system. This ensures that the models stay up-to-date with changing patterns and characteristics in the data.

Incremental Learning, instead of retraining the models from scratch, the system incrementally updates the models with new data while preserving the knowledge learned from previous training sessions. This approach reduces computational costs and allows for continuous adaptation to new data.

Online Learning, where the system employs online learning techniques, where the models are updated in real-time as new data becomes available. Examples of such algorithms include, but are not limited to, Stochastic Gradient Descent (SGD), Adaptive Learning Rate Methods and Online Bayesian Learning. This ensures that the models can quickly adapt to sudden changes or anomalies in the data without waiting for scheduled retraining sessions.

Parameter Tuning, wherein the calibration module adjusts the hyperparameters of the machine learning algorithms based on performance feedback. This optimization process fine-tunes the models to improve their accuracy and generalization capabilities.

Anomaly Detection, wherein the system monitors the performance metrics of the models and detects anomalies or deviations from expected behavior. When anomalies are detected, the calibration module investigates the root causes and applies corrective actions to restore optimal performance.

User Feedback, wherein users or caregivers provide feedback on the system's performance, such as false alarms or missed detections. The calibration module analyzes this feedback and uses it to identify areas for improvement, such as adjusting threshold values or refining feature extraction techniques.

Dynamic Threshold Adjustment where, the system dynamically adjusts threshold values used for decision-making based on historical performance data and current environmental conditions. This adaptive thresholding approach ensures that the system can effectively differentiate between normal variations and true fall events.

Accordingly, the systems and methods described above with respect to embodiments of the invention provide a solution for monitoring activities and recognizing incidents, particularly falls, within indoor environments. By leveraging wireless signals and advanced artificial intelligence and signal processing techniques, the system can accurately detect significant activity events in real-time, distinguishing between normal daily activities and abnormal incidents like falls. Through the integration of machine learning and feature extraction methodologies, the fall detection model achieves high accuracy and reliability in identifying fall-like events. Additionally, the system incorporates real-time evaluation and postprocessing methods to make prompt decisions regarding fall detection status, ensuring timely intervention when necessary. Furthermore, by considering auxiliary information such as environmental attributes, behavioral patterns, and biological demographics, our system enhances the accuracy of fall detection and prediction. The inclusion of a fall prediction model further enhances the system's capabilities, allowing for the identification of behavioral risk attributes and the calculation of probabilistic scores to predict the likelihood of a fall occurrence. Finally, the provision for system recalibration ensures ongoing performance optimization and adaptability to changing environmental conditions, thus maintaining the system's effectiveness over time. Overall, the invention represents a significant advancement in the field of fall detection and prediction, offering a robust and versatile solution for improving safety and well-being within indoor environments.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps, and means described above may be done in various ways. For example, these techniques, blocks, steps, and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory content. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, non-volatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to, portable or fixed storage devices, optical storage devices, wireless channels and/or various other mediums capable of storing, containing, or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. M any variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A system comprising:
a plurality of wireless devices, each wireless device associated with a predetermined region of a sensing area and operating according to a common wireless standard; and
a device comprising at least a processor and a memory for storing computer executable instructions which when executed by the processor configure the device to:
receive and store a plurality of metrics extracted from wireless signals transmitted and received by the plurality of wireless enabled devices;
process the extracted plurality of metrics; and
establish at least one of detection of a fall by a user within the predetermined region of the sensing area and a prediction of another fall by another user within the predetermined region of the sensing area.

2. The system according to claim 1, wherein
the plurality of metrics further comprises:
one or more metrics extracted from one or more of a sensor and a vital signs monitoring device which are employed in the detection of the fall by the user; and
one or more other metrics extracted from one or more of another sensor, another vital signs monitoring device, a medication software application and a nutritional tracking software application.

3. The system according to claim 1, wherein
the plurality of metrics extracted comprise one or more of:
channel state information of a first wireless channel of a plurality of wireless channels employed by the plurality of wireless enabled devices,
a frequency response of a second wireless channel of the plurality of wireless channels employed by the plurality of wireless enabled devices;
a phase response of a third wireless channel of the plurality of wireless channels employed by the plurality of wireless enabled devices;
an impulse response of a fourth wireless channel of the plurality of wireless channels employed by the plurality of wireless enabled devices;
one or more interface metrics extracted from one or more network interface cards associated with the system.

4. The system according to claim 1, wherein
establishing detection of the fall by the user within the predetermined region of the sensing area is established by a fall detection module of the system which executes a process comprising the steps of:
extracting with one or more processing techniques features from the plurality of metrics;
processing the extracted features to scale and normalize them to a common scale;
executing representative learning on the processed extracted features to establish essential characteristics of the processed extracted features; and
employing a machine learning process which processes the essential characteristics of the processed extracted features to detect the fall event from normal activities of the user.

5. The system according to claim 4, wherein
establishing detection of the fall by the user within the predetermined region of the sensing area is established by a fall detection module of the system which executes a process comprising the steps of:
extracting with one or more processing techniques features from the plurality of metrics;
processing the extracted features to scale and normalize them to a common scale;
executing representative learning on the processed extracted features to establish essential characteristics of the processed extracted features; and
employing one or more machine learning processes which process the essential characteristics of the processed extracted features in conjunction with other metrics to detect the fall event from normal activities of the user; and
the other metrics are extracted from one or more of a sensor and a vital signs monitoring device and each other metric is time synchronized to a defined subset of the plurality of metrics.

6. The system according to claim 1, wherein
establishing prediction of the other fall by the other user within the predetermined region of the sensing area is established by a fall detection module of the system which executes a process comprising the steps of:
extracting with one or more processing techniques features from the plurality of metrics;
processing the extracted features to scale and normalize them to a common scale;
executing representative learning on the processed extracted features to establish essential characteristics of the processed extracted features; and
employing one or more machine learning processes which process the essential characteristics of the processed extracted features in conjunction with other metrics to predict the other fall event of the other user; and
the other metrics are extracted from one or more of a sensor, a vital signs monitoring device, a medication software application associated with the other user and a nutritional tracking software application associated with the other user and each other metric is time synchronized to a defined subset of the plurality of metrics.

7. The system according to claim 1, wherein
the computer executable instructions when executed by the processor configure the device to process the extracted plurality of metrics in dependence upon a machine learning structure;
the machine learning structure is established in dependence upon historical data of the plurality of metrics for the predetermined region of the sensing area and associated occupancy data predetermined region of the sensing area; and
the machine learning structure provides robust performance in a range of environmental settings.

8. The system according to claim 1, wherein
the computer executable instructions when executed by the processor configure the device to process the extracted plurality of metrics in dependence upon a machine learning structure;
the machine learning structure is established in dependence upon an offline training method which establishes an initial robust model for occupancy detection using training data obtained over a range of different input settings.

9. The system according to claim 1, wherein
the computer executable instructions when executed by the processor configure the device to process the extracted plurality of metrics in dependence upon a machine learning structure;
stability of the machine learning structure is enhanced through the use of environmental state change configuration data extracted from the plurality of wireless signals.

10. The system according to claim 1, wherein
the computer executable instructions when executed by the processor configure the device to process the extracted plurality of metrics in dependence upon a machine learning structure;
stability of the machine learning structure is enhanced by augmenting a training set employed to generate the machine learning structure improve its representation of a sensing environment associated with the predetermined region of the sensing area.

11. A system comprising:
a device comprising at least a processor and a memory for storing computer executable instructions which when executed by the processor configure the device to:
extract a plurality of metrics from a memory in communication with the device where the plurality of metrics were extracted from wireless signals transmitted and received by a plurality of wireless enabled devices associated with a predetermined region of a sensing area and operating according to a common wireless standard;
process the extracted plurality of metrics; and
establish at least one of detection of a fall of a user within the predetermined region of the sensing area and a prediction of another fall by another user within the predetermined region of the sensing area.

12. The system according to claim 11, wherein
the plurality of metrics further comprises:
one or more metrics extracted from one or more of a sensor and a vital signs monitoring device which are employed in the detection of the fall by the user; and
one or more other metrics extracted from one or more of another sensor, another vital signs monitoring device, a medication software application and a nutritional tracking software application.

13. The system according to claim 11, wherein
the plurality of metrics extracted comprise one or more of:
channel state information of a first wireless channel of a plurality of wireless channels employed by the plurality of wireless enabled devices,
a frequency response of a second wireless channel of the plurality of wireless channels employed by the plurality of wireless enabled devices;
a phase response of a third wireless channel of the plurality of wireless channels employed by the plurality of wireless enabled devices;
an impulse response of a fourth wireless channel of the plurality of wireless channels employed by the plurality of wireless enabled devices;
one or more interface metrics extracted from one or more network interface cards associated with the system.

14. The system according to claim 11, wherein
establishing detection of the fall by the user within the predetermined region of the sensing area is established by a fall detection module of the system which executes a process comprising the steps of:
extracting with one or more processing techniques features from the plurality of metrics;
processing the extracted features to scale and normalize them to a common scale;
executing representative learning on the processed extracted features to establish essential characteristics of the processed extracted features; and
employing a machine learning process which processes the essential characteristics of the processed extracted features to detect the fall event from normal activities of the user.

15. The system according to claim 14, wherein
establishing detection of the fall by the user within the predetermined region of the sensing area is established by a fall detection module of the system which executes a process comprising the steps of:
extracting with one or more processing techniques features from the plurality of metrics;
processing the extracted features to scale and normalize them to a common scale;
executing representative learning on the processed extracted features to establish essential characteristics of the processed extracted features; and
employing one or more machine learning processes which process the essential characteristics of the processed extracted features in conjunction with other metrics to detect the fall event from normal activities of the user; and
the other metrics are extracted from one or more of a sensor and a vital signs monitoring device and each other metric is synchronized to a defined subset of the plurality of metrics.

16. The system according to claim 11, wherein
establishing prediction of the other fall by the other user within the predetermined region of the sensing area is established by a fall detection module of the system which executes a process comprising the steps of:
extracting with one or more processing techniques features from the plurality of metrics;
processing the extracted features to scale and normalize them to a common scale;
executing representative learning on the processed extracted features to establish essential characteristics of the processed extracted features; and
employing one or more machine learning processes which process the essential characteristics of the processed extracted features in conjunction with other metrics to predict the other fall event of the other user; and
the other metrics are extracted from one or more of a sensor, a vital signs monitoring device, a medication software application associated with the other user and a nutritional tracking software application associated with the other user and each other metric is time synchronized to a defined subset of the plurality of metrics.

17. The system according to claim 11, wherein
the computer executable instructions when executed by the processor configure the device to process the extracted plurality of metrics in dependence upon a machine learning structure;
the machine learning structure is established in dependence upon historical data of the plurality of metrics for the predetermined region of the sensing area and associated occupancy data predetermined region of the sensing area; and
the machine learning structure provides robust performance in a range of environmental settings.

18. The system according to claim 11, wherein
the computer executable instructions when executed by the processor configure the device to process the extracted plurality of metrics in dependence upon a machine learning structure;
the machine learning structure is established in dependence upon an offline training method which establishes an initial robust model for occupancy detection using training data obtained over a range of different input settings.

19. The system according to claim 11, wherein
the computer executable instructions when executed by the processor configure the device to process the extracted plurality of metrics in dependence upon a machine learning structure;
stability of the machine learning structure is enhanced through the use of environmental state change configuration data extracted from the plurality of wireless signals.

20. The system according to claim 11, wherein
the computer executable instructions when executed by the processor configure the device to process the extracted plurality of metrics in dependence upon a machine learning structure;
stability of the machine learning structure is enhanced by augmenting a training set employed to generate the machine learning structure improve its representation of a sensing environment associated with the predetermined region of the sensing area.
